(19) United States
(12) Patent Application Publication
(10) Pub. No.: US 2010/0282361 A1
(43) Pub. Date: Nov. 11, 2010

(54) PREPARING A TITRATION SERIES

(76) Inventor: Kevin F. Peters, Corvallis, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/743,547

(22) PCT Filed: Nov. 24, 2008
(86) PCT No.: PCT/US2008/084567

§ 371 Date: May 18, 2010

Related U.S. Application Data
(60) Provisional application No. 61/004,365, filed on Nov. 27, 2007.

(51) Int. Cl. B65B 1/04; B41J 2/04

(52) U.S. Cl. 141/1; 141/83; 141/82; 347/54

(57) ABSTRACT

A titration series is prepared. Reagent is loaded into a reagent reservoir within a fluid ejection device. Reagent is ejected from the fluid ejection device into a plurality of receptacles so that an amount of reagent ejected from the fluid ejection device into a first receptacle in the plurality of receptacles is at least 10,000 times an amount of reagent ejected from the fluid ejection device into a second receptacle in the plurality of receptacles.

### BACKGROUND

When performing testing of substances such as drugs or other chemicals in a liquid, doses of a reagent are transferred to receptacles. Often it is desirable to conduct tests in which dose amounts vary significantly, for example, over five to eight orders of magnitude,

Because of limitations in the accuracy of providing small reagent dose amounts directly to a receptacle, it is customary to add a reagent dose to an receptacle and then serially dilute the resulting reagent into additional receptacles in a series of dilution steps until the desired series of reagent concentrations are obtained. Such serial dilutions can be slow, error-prone and wasteful.

It is desirable to provide a way to introduce small reagent doses directly to a receptacle without the requirement of using serial dilutions.

### BRIEF DESCRIPTION OF THE DRAWINGS

FIG. 1 is a simplified block diagram of a dosing system in accordance with an embodiment of the present invention.

FIG. 2 is a simplified block diagram showing additional detail pertaining to fluid ejection devices within the dosing system shown in FIG. 1 in accordance with an embodiment of the present invention.

FIG. 3, FIG. 4 and FIG. 5 show various arrangements of nozzles on fluid ejection devices in accordance with embodiments of the present invention.

FIG. 6 is a flowchart that describes dosing of a reagent into receptacles in accordance with an embodiment of the present invention.

### DESCRIPTION OF THE EMBODIMENT

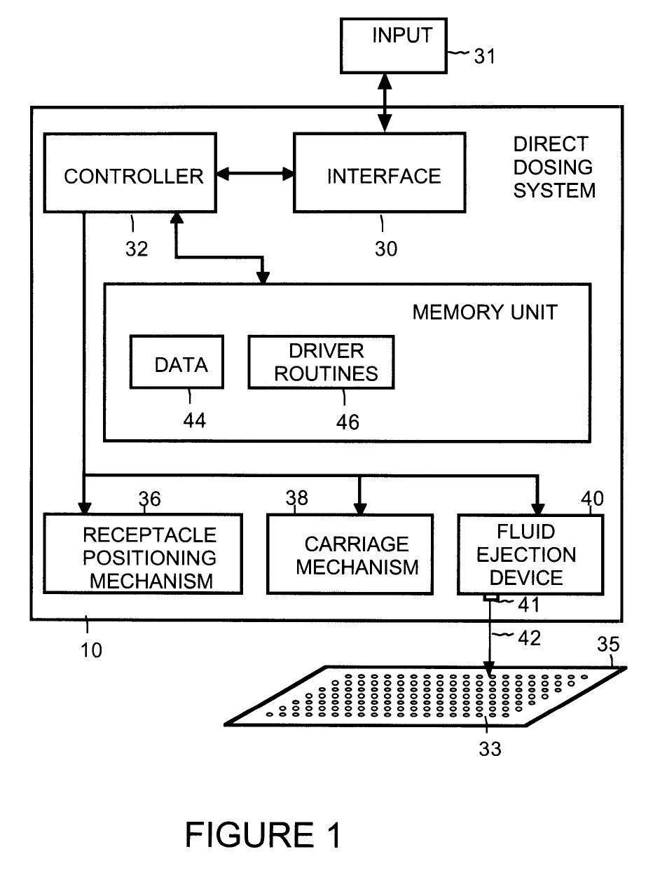

FIG. 1 is a simplified block diagram of a dosing system 10. Dosing system 10 includes, for example, a controller 32 that, via an interface unit 30, can receive input 31 from a computer system or some other device. The interface unit 30 facilitates the transferring of data and command signals to controller 32 for dosing purposes.

In order to store data, at least temporarily, dosing system 10 includes a memory unit 34. For example, memory unit 34 is divided into a plurality of storage areas that facilitate dosing operations. The storage areas include a data storage area 44 and driver routines 46.

Data area 44 stores data files that define dose amounts to be placed within receptacles 33 on a receptacle tray 35. Driver routines 46 contain routines for controlling the dosing process. Driver routines 46 include, for example, the routines that control a receptacle positioning mechanism for moving the receptacle tray 35 in preparation for dosing. Driver routines 46 also can include, for example, the routines that control a carriage mechanism 38 that causes a fluid ejection device carriage unit to be moved over various receptacles. For example a single fluid ejection device carriage may be used to transport many fluid ejection devices. For example the reagent used for reagent doses is a sample such as an experimental drug sample. Alternatively, the reagent may be another chemical that gets combined in a receptacle with a sample. In this case the reagent may be, for example, a DNA primer used in a polymerase chain reaction to replicate a particular region of DNA, that gets combined in a receptacle with a sample.

In operation, dosing system 10 responds to commands to place reagent doses into receptacles 33.

Controller 32 forwards firing data to one or more fluid ejection devices, represented in FIG. 1 by a fluid ejection device 40. For example, fluid ejection device 40 is a thermal inkjet printhead or some other entity capable of ejecting fluid such as a multi-nozzle drop generator or a thin film piezo-MEMS inkjet printing device. The firing data sent to fluid ejection device 40 is used to control the fluid ejection elements associated with the nozzles of fluid ejection device 40. This is represented in FIG. 1 by reagent 42 being ejected from a nozzle 41.

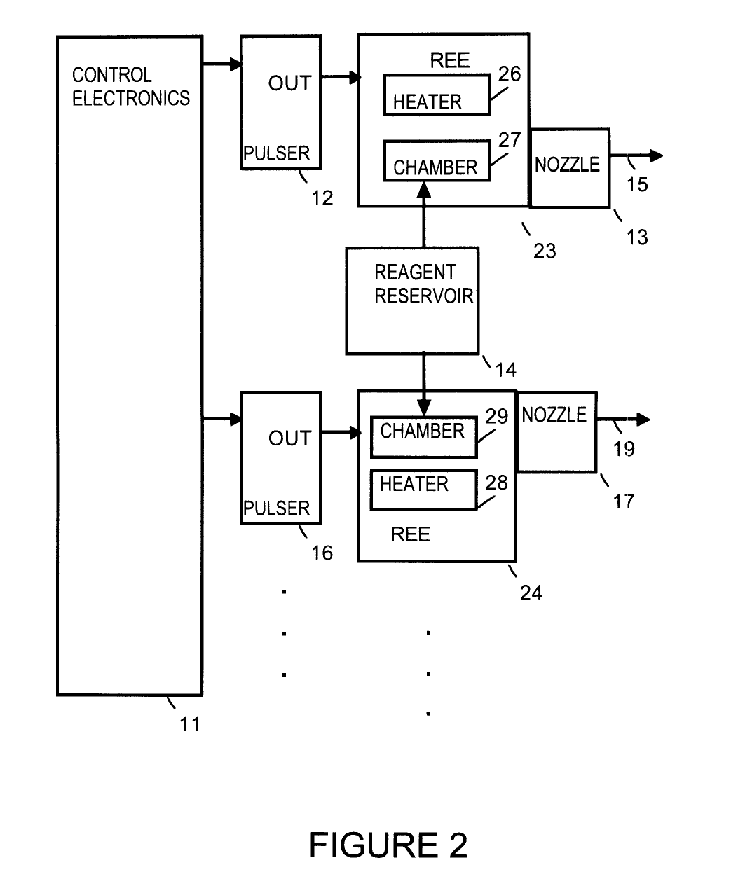

For example, as shown in FIG. 2, firing data is used by a pulser 12 to generate pulses that control a reagent ejection element (REE) 23 associated with a nozzle 13 located on a fluid ejection device 40. Pulser 12 may be located on or off fluid ejection device 40, depending on the particular embodiment of the present invention. In the example shown in FIG. 2, control electronics 11 provides to pulser 12 fluid ejection device firing data including information that sets the pulse rate and information that indicates which pulses are to be forwarded to reagent ejection element 23. For example, control electronics 11 are included within controller 32. The pulses forwarded to reagent ejection element 23 are forwarded as a current pulse that is applied to a heater 26 within reagent ejection element 23. For example heater 26 is a resistor. The current pulse through heater 26 provides thermal energy that causes reagent within chamber 27 to vaporize or partially vaporize and to be emitted from nozzle 13 as a reagent droplet 15. In between firing cycles, chamber 27 is refilled with reagent from reagent reservoir 14.

Fluid ejection device firing data generated by controller 32 is also used by a pulser 16 to generate pulses that control a reagent ejection heating element (REE) 24 associated with a nozzle 17. Control electronics 11 provides to pulser 16 fluid ejection device firing data that sets the pulse rate and indicates which pulses are to be forwarded to reagent ejection element 24. The pulses forwarded to reagent ejection element 24 are forwarded as a current pulse that is applied to a resistor within reagent ejection element 24. The pulses forwarded to reagent ejection element 24 are forwarded as a current pulse that is applied to a heater 28 within reagent ejection element 24. For example, heater 28 is a resistor. The current pulse through heater 28 provides thermal energy that causes reagent within chamber 29 to vaporize or partially vaporize and to be emitted from nozzle 17 as a reagent droplet 19. In between firing cycles, chamber 29 is refilled with reagent from reagent reservoir 14.

For example, nozzle 15, nozzle 17 and reagent reservoir 14 are all located on fluid ejection device 40. Nozzle 15 and nozzle 17 are exemplary as each fluid ejection device can have many nozzles.

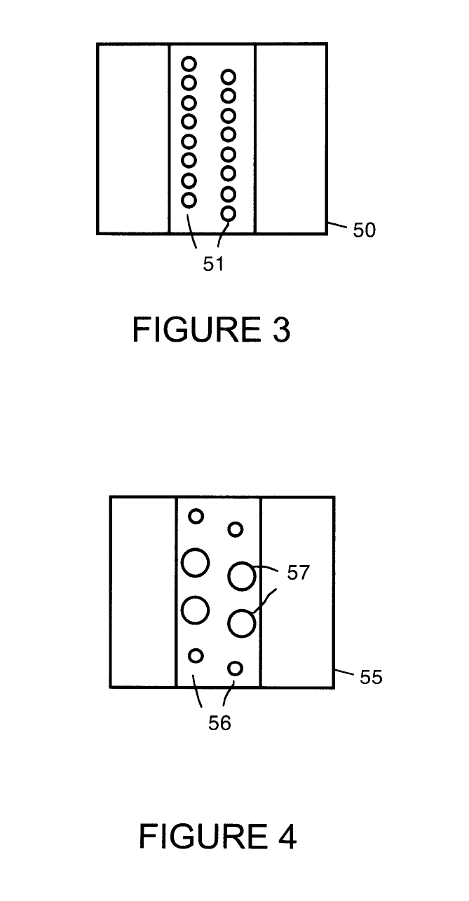

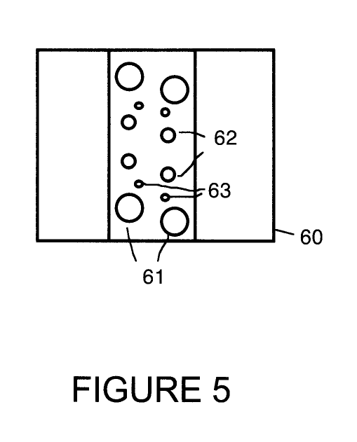

For example, FIG. 3, FIG. 4 and FIG. 5 show various arrangements of nozzles on fluid ejection devices. In FIG. 3, sixteen nozzles 51 are arranged on a fluid ejection device 50. For example, fluid ejection device 50 is implemented by a 1.3 millimeter (mm) by 2.5 mm die. As will be understood by persons of skill in the art, the number of nozzles per fluid ejection device and the dimensions of the fluid ejection device will vary depending upon desired design constraints.

For example, each of nozzles 51 has a diameter of 30 microns allowing for the ejection of droplets of about 10 picoLiters (pL), depending upon many parameters in addition to nozzle diameter, such as chamber dimensions, ejection energy, reagent boiling temperature, reagent viscosity and so on.

In FIG. 4, four smaller nozzles 56 and four larger nozzles 57 are arranged as shown on a fluid ejection device 55. For example, fluid ejection device 55 is implemented by a 1.3 millimeter (mm) by 2.5 mm die. For example, each of nozzles 56 has a diameter of 30 microns allowing for the ejection of droplets of about 10 picoLiters (pL), depending upon many parameters in addition to nozzle diameter, as discussed above. For example, each of nozzles 57 has a diameter of 50 microns allowing for the ejection of droplets of about 100 picoLiters (pL), depending upon many parameters in addition to nozzle diameter, as discussed above.

In FIG. 5, four smaller nozzles 63, four intermediate sized nozzles 62 and four larger nozzles 61 are arranged as shown on a fluid ejection device 60. For example, fluid ejection device 60 is implemented by a 1.3 mm by 2.5 mm die. For example, each of nozzles 63 has a diameter of about 3 microns allowing for the ejection of droplets of about 0.06 pL, depending upon many parameters in addition to nozzle diameter, as discussed above. For example, each of nozzles 62 has a diameter of 30 microns allowing for the ejection of droplets of about 10 pL, depending upon many parameters in addition to nozzle diameter, as discussed above. For example, each of nozzles 61 has a diameter of 50 microns allowing for the ejection of droplets of about 100 picoLiters (pL), depending upon many parameters in addition to nozzle diameter, as discussed above.

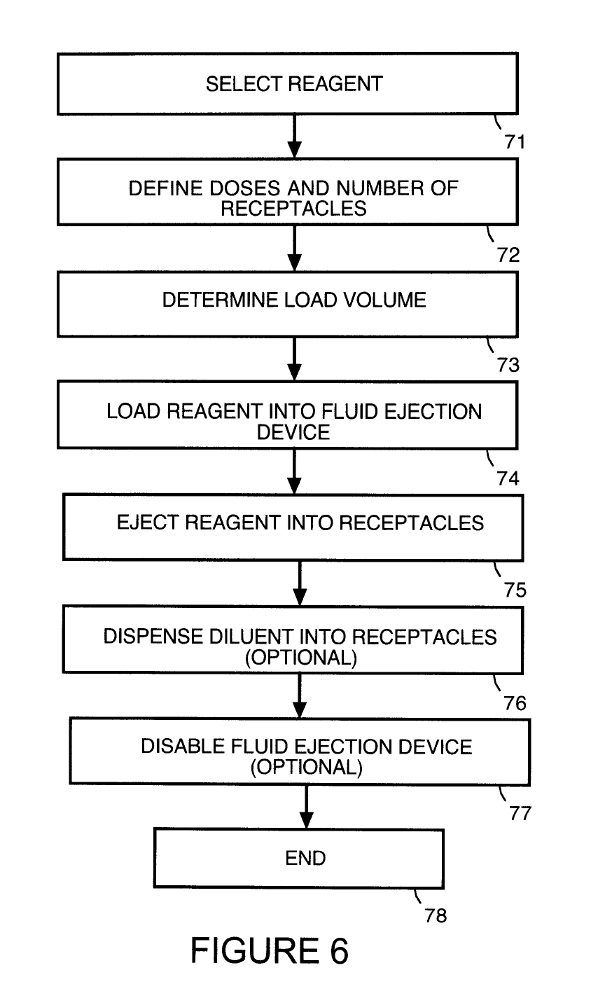

FIG. 6 is a flowchart that describes dosing of reagents into a receptacle. In a block 71, the particular type of reagent is selected. For example, the reagent is an experimental drug compound that has been dissolved at 10 milliMolar concentration in DMSO solvent, or any other type of reagent that is to be dosed. The type of reagent will be selected based on the type of test to be performed and the type of assay which is to be used for the test. Another example is the Dose-Response analysis of the potency of an experimental drug that reacts to inhibit an assay of a molecular disease target. Here, the experimental drug is typically titrated from concentrate at 10 millirnolar to a series of increasingly dilute concentrations from 100 micromolar down to 1 nanomolar, for example.

In a block 72, the details of the test are defined. For example, range of dilution to be tested is determined. Also the number of receptacles to be used is defined and the volume and type of assay in each receptacle is determined. For example, a typical test will require the receptacles to be dosed to twelve different reagent concentrations spanning six orders of magnitude (six decades), the spacing between reagent concentrations being at half an order of magnitude (half decade). The testing is typically performed in triplicate so that three receptacles are dosed for each reagent concentration, requiring dosing of thirty-six receptacles for each test.

For example, if after placing reagent in a receptacle to produce an assay within the receptacle, the highest reagent concentration for the assay is 1×10⁻⁴ molar, then a typical test might additionally require assays with the following reagent concentrations: 1×10⁻⁴ molar, 3×10⁻⁵ molar, 1×10⁻⁵ molar, 3×10⁻⁶ molar, 1×10⁻⁶ molar, 3×10⁻⁷ molar, 1×10⁻⁷ molar, 3×10⁻⁸ molar, 1×10⁻⁸ molar, 3×10⁻⁹ molar, 1×10⁻⁹ molar, and 3×10⁻¹⁰ molar. The above described test is a titration series that includes concentrations that are evenly spaced at twelve points over six orders of magnitude at half-decade concentrations from 3×10⁻¹⁰ molar up to 1×10⁻⁴ molar. If a particular test requires more decades of dose range than a single fluid ejection device can enable, then a second fluid ejection device can be used into which is loaded pre-diluted reagent. This use of pre-diluted reagent allows for smaller concentrations of reagent to be placed in receptacles.

While a typical test may use, in triplicate, twelve different doses, with resulting dose concentrations separated by a half decade, it will be understood by persons of ordinary skill in the art that the parameters for tests can vary widely dependent upon desired testing criteria. The amount of redundancy, the number of doses and the particular dose concentrations can vary depending upon the particular study being performed.

Evenly spaced titration series are commonly used for testing; however, a particular test may require a titration series that is unevenly spaced across concentration decades. For example, a user may have some prior knowledge of an expected outcome of assays performed across a full titration range. For example, the user may expect that an assay becomes inhibited by a given inhibitor at a dose of approximately 1×10⁻⁸ molar and may therefore desire to dose at, for example: 1×10⁻⁵ molar, 1×10⁻⁸ molar, 3×10⁻⁷ molar, 1×10⁻⁷ molar, 5×10⁻⁸ molar, 3×10⁻⁸ molar, 2×10⁻⁸ molar, 1×10⁻⁸ molar, 5×10⁻⁹ molar, 3×10⁻⁹ molar, 1×10⁻⁹ molar, 7×10⁻¹⁰ molar, and 3×10⁻¹⁰ molar. This unevenly distributed titration series provides for optimal return of assay information across the titration series while saving the effort and investment of doing an assay at a dose—such as, 3×10⁻⁶ molar—where the assay result might be less informative.

In a block 73, total load volume for a fluid ejection device is determined. This optional block is used to prevent reagent waste. For example, the reagent reservoir, such as reagent reservoir 14 shown in FIG. 2, is sufficiently large to hold enough reagent to provide the thirty-six reagent doses required for a typical test. The total load volume is determined by summing the required amount of reagent to perform all the doses and then including a bit more to assure that the amount of reagent in the reagent reservoir will be more than sufficient to perform the test. If a particular test were to require more reagent than could be contained in the reagent reservoir for a single fluid ejection device, multiple fluid ejection devices or multiple loading of the single fluid ejection device would be used for the test. Calculation of the total load volume can be eliminated for those cases where efficient use of reagent is not important. In this case, a reagent reservoir can be filled and utilized and the extra reagent can simply be discarded.

In a block 74, the determined amount of load volume of the reagent is loaded into the reagent reservoir of the fluid ejection device. This is done, for example, using a micro pipette or a pin. The fluid ejection device may require a minimum amount of reagent (e.g. 1 microLiter) to be placed in the reagent reservoir for correct operation. In addition, the reagent reservoir will have a maximum capacity selected by the manufacturer. Typically this will be selected based on the capacity that is anticipated to perform tests. At this point, a tray of receptacles would be loaded into the dosing system in preparation to receive doses of the reagent.

In a block 75, the reagent doses are ejected from the fluid ejection device into the receptacles. This is done by positioning one or more fluid ejection devices over each receptacle and firing one or more nozzles of the fluid ejection device until the correct dose volume of the reagent has been transferred into the receptacle. The minimum dosing increment is a single drop. The minimum dosing increment can be as small as 0.06 picoLiters, in accordance with an example given above.

The number of drops (D) required to be transferred into each receptacle depends on the required reagent concentration (R_{C}) in the receptacle, the volume of assay in the receptacle (Vₐ), the volume per drop (V_{D}), and the concentration of reagent (D_{C}) in each drop, calculated as set out in Equation 1 below:

D=R_{C}*Vₐ/(V_{D}*D_{C})

Versatility can be added by using different size drops, controlled by nozzle size and other parameters as discussed above. Dose size is limited by the smallest drop size. For example, for the nozzle arrangement shown in FIG. 5, a drop size of 0.01 pL is possible. The nozzle arrangement shown in FIG. 5 also has four nozzles able to produce drops with a volume of 100 Dose time is limited by the drop size or sizes and by the number of drops of that size or sizes. For example, when a fluid ejection device fires 100 pL droplets from ten nozzles fires at a firing frequency of approximately 50,000 Hertz per nozzle, a dose volume of 5 microliters can be achieved in approximately 0.1 seconds. For example, having a smallest drop size of 5 picoLiters enables a smallest dose size, and further having a largest drop size of 10 picoLiters may in most cases reduce the dose time by half.

In a block 76, additional diluent can be dispensed into the receptacles. This dilution of the assay with an additional diluent can be performed before or after reagent is placed in the receptacles, or not at all depending on the requirements of a particular test. In most cases, use of a fluid ejection device to provide reagent will allow the generation of a titration series without the use of any additional diluent nor an intermediate dilution receptacle. The fluid ejection device provides the reagent directly into the receptacle where it is combined with other reagents to form an assay.

In a block 76, the fluid ejection device is disabled from dispensing additional reagent. For example, the fluid ejection device is disabled by discarding or destroying the fluid ejection device. This is done, for example, to prevent future contamination. This step can be optional, dependent upon the test performed, the reagent used and the testing protocols. In a block 77, the dosing of the reagent is complete.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

1. A method for preparing a titration series, comprising:
loading reagent into a reagent reservoir within a fluid ejection device; and,
ejecting reagent from the fluid ejection device into a plurality of receptacles so that an amount of reagent ejected from the fluid ejection device into a first receptacle in a plurality of receptacles is at least 10,000 times an amount of reagent ejected from the fluid ejection device into a second receptacle in the plurality of receptacles.

2. A method as in claim 1 wherein ejecting reagent includes:
transferring reagent from the reagent reservoir into a chamber of the fluid ejection device; and,
vaporizing a portion of reagent within the chamber so that the reagent within the chamber is ejected from the chamber through a nozzle into the receptacle.

3. A method as in claim 1 wherein ejecting reagent includes:
ejecting drops from a nozzle of the fluid ejection device at a firing frequency above 5000 Hertz.

4. A method as in claim 1 wherein ejecting reagent includes:
ejecting from the fluid ejection device a drop of reagent, the drop having a volume that is less that 100 picoliters.

5. (canceled)

6. A method as in claim 1 wherein ejecting reagent includes:
ejecting drops from a plurality of nozzles of the fluid ejection device, so that first drops ejected from a first nozzle in the plurality of nozzles have at least twice the volume of second drops ejected from a second nozzle in the plurality of nozzles.

7. (canceled)

8. A method as in claim 1 wherein ejecting reagent from the fluid ejection device includes distributing reagent into the plurality of receptacles so that the titration is unevenly spaced across concentration decades.

9. A method as in claim 1, further comprising adding a volume of diluent to the receptacles to dilute to desired concentrations reagent ejected into the plurality of receptacles.

10. (canceled)

11. A method as in claim 1 where the reagent is an experimental drug reagent.

12. A method as in clam 1 additionally comprising:
adding a second reagent into the plurality of receptacles, and measuring resultant reagent mixtures.

13. (canceled)

14. A dosing system for preparing a titration series, comprising:
a fluid ejection device, the fluid ejection device including:
a reagent reservoir used to hold reagent, and
a plurality of nozzles arranged to provide the fluid ejection device capability of ejecting reagent through the nozzles into a plurality of receptacles so that an amount of reagent ejected from the fluid ejection device into a first receptacle in a plurality of receptacles is at least 10,000 times an amount of reagent ejected from the fluid ejection device into a second receptacle in the plurality of receptacles.

15. A dosing system as in claim 14 wherein the plurality of nozzles includes nozzles of at least two different diameters.

16. (canceled)

17. A dosing system as in claim 14 additionally comprising:
the plurality of receptacles; and
a mechanism that positions the receptacles with respect to the fluid ejection device so that reagent ejected through a nozzle enters a corresponding one of the receptacles.

18. (canceled)

19. A dosing system as in claim 14 wherein each nozzle in the plurality of nozzles is associated with a chamber from a plurality of chambers that receive reagent from the reagent reservoir and with a heater from a plurality of heaters, wherein the fluid ejection device ejects reagent using a heater to vaporize a portion of reagent within a chamber so that the reagent within the chamber is ejected from the chamber through an associated nozzle.

20-24. (canceled)

25. A fluid ejection device, comprising:
a reservoir for holding a reagent;
a thermal inkjet printhead or a piezoelectric inkjet printhead in fluid communication with the reagent reservoir, the printhead configured to eject reagent from the reservoir in varying amounts in which the amount of one ejection is at least 10,000 the amount of another ejection.

26. A fluid ejection device as in claim 25, wherein the printhead is further configured to eject drops of reagent at a frequency above 5000 Hertz.
